(19) United States
(12) Patent Application Publication
(10) Pub. No.: US 2009/0327145 A1
(43) Pub. Date: Dec. 31, 2009

(54) Payment System and Method

(76) Inventors: David Roy Dent, Hampshire (GB); Brian Robert Pettit, Kent (GB)

Correspondence Address: Ballard Spahr LLP, SUITE 1000, 999 PEACHTREE STREET, ATLANTA, GA, 30309-3915, US

(21) Appl. No.: 12/224,757

(22) PCT Filed: Mar. 16, 2007
(86) PCT No.: PCT/GB2007/000924

§ 371 Date: Feb. 17, 2009

(30) Foreign Application Priority Data
Mar. 16, 2006 (GB) 0605281

(51) Int. Cl. G06Q 20/00; G06Q 10/00; G06F 15/16

(52) U.S. Cl. 705/78; 705/21; 705/17; 705/44; 705/30; 709/204

(57) ABSTRACT

A card terminal having means for entering transaction value information indicative of a first amount, means for entering data indicative of an additional amount, means for storing the transaction value information and the data indicative of the additional amount, and means for creating a message for electronic transmission, the message including data indicative of the first amount in association with data indicative of a first recipient, and data indicative of the additional amount in association with data indicative of a second recipient.

### FIELD OF THE INVENTION

This invention relates generally to the field of payment systems and methods of payment.

Preferred embodiments relate to a computerized payment system, to card terminal, to a merchant acquirer computer system and to a method of payment. Embodiments relate to generating and processing revenue for third party purposes through the electronic fund transfer (electronics funds transfer) system.

### BACKGROUND OF THE INVENTION

The electronic funds transfer system of payment is now well established. In a conventional transaction, a user is required to input information to a card terminal at a merchant location. This information is passed to a merchant acquirer that can be regarded as the card terminal operator. The merchant acquirer passes the information through to a card provider, also known as “card issuer” at which the user's card has an account. A card is a payment device. The card provider checks the information and if appropriate authorizes the transaction, sending information back to the merchant terminal. At some point, the user is billed for the transaction—a bill with a batch of transactions is the usual way—and funds reach the merchant from the card provider.

Conventionally participants in the system receive commission for their activities.

Known systems that address the issues of making payments to third parties, such as charities, in response to paying for purchases have considered the following issues:
rounding up of all payment transactions to the nearest whole dollar to create an excess over cost, and the use of that excess for specific purposes unrelated to the type of merchandise purchased
payer offerings
neutral, i.e. unrecompensed, merchants who enter data and funds into remote point of sale terminals
predetermination of allocation of funds
pre assigned identifiers as specific purpose donor cards or carried on
particular credit/debit card to identify the transactor and their prior predetermined allocation of funds
establishment of specific individual transactor accounts under the control of the transactor that enable the predetermined transfer of funds between the transactor account and a range of other accounts including those of charitable causes.

However, known systems require predetermination by a customer that they wish to authorise a service provider to issue a dedicated card identifier to enable the process of transfer of funds between predetermined accounts under the control of the customer.

Such systems do not generally provide benefit to the merchant in managing the process of entering data and funds, nor benefit to the merchant account provider, the card scheme or the card issuer above the interchange fee for the increased purchase volume.

Embodiments of the present invention may enable:
Spontaneity in deciding to pay additional amounts for third party purposes at point of sale
A mechanism to enable a merchant to be reimbursed for the cost of providing the service;
Different fee structures for the additional amount to all parties
A third part recipient to be credited by any party in the network,

Embodiments:
involve an additional party to the system (the third party recipient) whose function is to consolidate all contributions and arrange disbursement
do not require transactors to take any previous action to initiate payment or to set up a system to allow payments to be made.

The system for dealing with payment due to credit or debit cards involves three or more parties. In the three party situation, these are the merchant, the merchant acquirer and the card issuer. Information representative of the cost of a purchase from a merchant, made by credit or debit card is passed to the hardware of the merchant's account provider, where software processes it. The payment system is typically managed by the card brand network whose role it is to consolidate payments from each merchant acquirer for each card issuer. To complete the circle the card issuers, who also supply the cards, bill the card holding customer who pays for the purchase at the end of the month. The whole payment system delivers efficient, secure and effective financial transactions for billions of people world wide. With an independent collating and disbursement capability integrated into this system along side any of the players then a payment additional to the purchase price, can efficiently and effectively deliver revenue to one or a number of third party recipients.

### SUMMARY OF THE INVENTION

In one aspect there is provided a card terminal having means for entering transaction value information indicative of a first amount, means for entering data indicative of an additional amount, means for storing the transaction value information and the data indicative of the additional amount, and means for creating a message for electronic transmission, the message including data indicative of the first amount in association with data indicative of a first recipient, and data indicative of the additional amount in association with data indicative of a second recipient.

The card terminal may further have means for creating a request for authorisation, said request indicative of the sum of the first and additional amounts.

The card terminal may have means for reception of an authorisation message, and means for enabling the means for creating a message to output the message in response to said reception.

The card terminal may have means for interacting with a card to determine whether authorisation is not deemed,necessary and means for enabling the means for creating a message to output the message in response to said determination.

The additional amount may be predetermined, and the means for entering an additional amount comprise a “confirm” key.

The means for entering an additional amount may allow a user to choose between predetermined amounts, or to enter an arbitrarily selected amount.

The card terminal may be operable to calculate a difference between the first amount and the next highest whole currency unit amount, and n the means for entering an additional amount may allow a user to elect said difference as said additional amount,

The card terminal may further comprise means for defaulting, in the event that no response is made to a “confirm” key after a predetermined period, to setting the additional amount to -zero or not including an additional amount in the message,

In another aspect there is provided a computer system having a transaction database, and a plurality of communication ports, having means for receiving a single message at a respective communication port, the message having predetermined fields containing data indicative of a first amount, data indicative of a first recipient, data indicative of an additional amount and data indicative of a second recipient and for storing the data indicative of a first amount in association with the data indicative of a first recipient, and the data indicative of an additional amount in association with the data indicative of a second recipient.

The remote computer system may be a merchant acquirer computer system.

In a further aspect there is provided a computerised payment system comprising a data entry device, a computer system remote from the data entry device, with a first communication path linking the data entry device to the computer system, and a second communication path linking the computer system to the data entry device, wherein the data entry device has means for inputting a first transaction data indicative of a first value, means for entering second transaction data indicative of a second value, and means for outputting information indicative of the first and second transactions to the first communication path for transfer to the computer system, and the computer system is operable to direct funds related to the first value to a first recipient and funds related to the second value to a second recipient.

In a still further aspect there is provided a method of electronic payment by a first party to a second party comprising: using a payment terminal, providing the first party with the opportunity to elect to pay to a third party a first amount additional to a second amount to be paid to the second party; if the first party elects to pay the additional amount, transferring information from the payment terminal to a remote merchant acquirer computer system, the information containing data indicative of the first amount, the second amount, the identity of the first party and the second party and the third party; and accessing the information, and using it to cause appropriate transfer of funds to the second and third parties.

The method may further comprise storing the information at the merchant acquirer computer system.

In a yet further aspect there is provided a method of electronic payment by a first party to a second party using a data carrier, comprising: using a payment terminal, providing the first party with the opportunity to elect to pay to a third party a first amount additional to a second amount to be paid to the second party; if the first party elects to pay the additional amount, transferring information from the payment terminal to a remote computer system, the information containing data indicative of the first amount, the second amount, the identity of the first party and the second party and the third party, the information further comprising data indicative of an issuer of the data carrier; storing the information at the merchant acquirer computer system; transferring selected items of stored data to the issuer of the data carrier whereby payment is made from the card issuer to the merchant account provider; processing the information and using it to cause appropriate transfer of funds to the second and third parties.

The remote computer system may be a remote merchant acquirer computer system.

The step of transferring selected items of stored data may comprise collecting together stored data relevant to respective card issuers, and sending respective batches of data to the relevant card issuers.

The method may further comprise an authorization step, in which the payment terminal transmits data indicative of the sum of the first and second amounts along with data indicative of the first party.

Data transmitted at least during the authorization step may be transmitted in encrypted form.

The authorization step may further comprise transferring authorization data to the payment terminal.

The step of transferring information from the payment terminal to a remote merchant acquirer computer system may be enabled in response to receipt of authorization data at the payment terminal.

In another aspect there is provided a payment system that is not wholly dependent on electronic funds transfer—for example uses cash.

### BRIEF DESCRIPTION OF THE DRAWINGS

FIG. 1 is a block diagram of an embodiment of an electronics funds transfer network showing flow of information,

FIG. 2 is a block diagram of an embodiment of the electronics funds transfer network of FIG. 1,

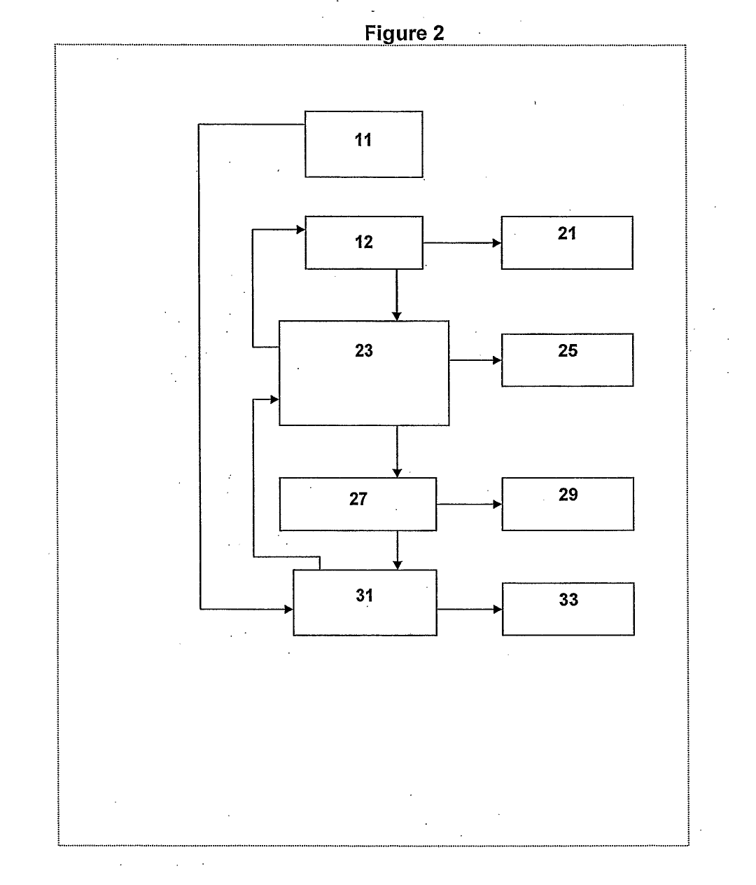

FIG. 3, a more comprehensive diagram of the interaction of the transactor with the electronics funds transfer network together with the third party recipient options.

### DETAILED DESCRIPTION OF A PREFERRED EMBODIMENT

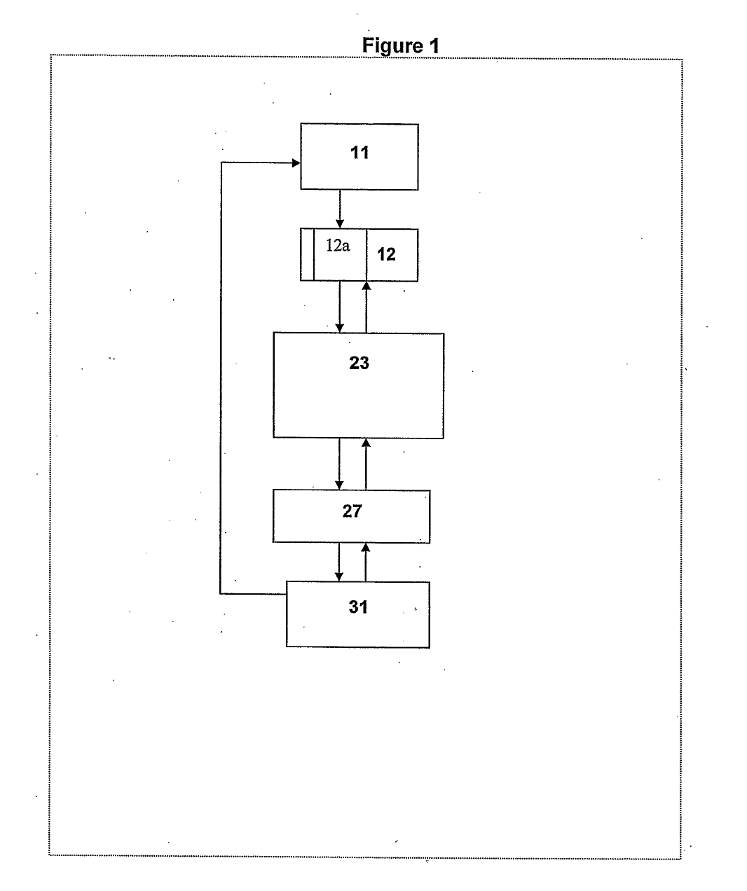

Referring to FIG. 1, a payment system 1 includes a user 11 referred to hereinafter as a “transactor”, a merchant 12, such as a shop, supermarket, department store, gasoline station, a merchant acquirer 23, a card scheme organisation 27 and a card provider 31. The merchant 12 here has a card terminal 12a. A first communication path 41 has portions as follows:
41a from card terminal 12a to merchant acquirer 23,
41b from merchant acquirer 23 to card scheme organisation 27,
41c from card scheme organisation 27 to card provider 31.

A second communication path 43 has portions as follows:
43a from the card provider 31 to the card scheme organisation 27;
43b from the card scheme organisation 27 to the merchant acquirer 23;
43c from the merchant acquirer 23 to the card terminal 12a.

Information may be provided from the transactor 11 to the card terminal 12a, this path being shown diagrammatically as 45. However this path is likely to involve physical interaction -for example inserting or swiping a card, entering numbers and otherwise.

It will be understood that a single two-way communication medium may be used; the invention is not restricted to wired communication paths. In embodiments, “merchant” may includes a computer or computer system of a merchant; “merchant acquirer” may includes a computer or computer system of a merchant account provider; “card scheme” may include a computer or computer system of a card scheme and “card issuer” may include a computer or computer system of a card issuer.

A merchant acquirer is a bank or other financial institution having a business relationship with merchants, retailers and other service providers to process their card transactions. The acquirer handles/processes debit and credit card transactions received, reimbursing the merchant for the amount of the sale and levying a service charge/commission for the service.

Each card may have identification information indicative of the issuing bank or other institution, and of the card scheme to which the card belongs. Examples of card schemes are Visa, MasterCard and American Express.

In a more complete representation of the system, there will typically be a relatively large number of card issuers, for example equating to a number of banks, a smaller number of card schemes, and each merchant may have access to only one merchant acquirer or to a small number of merchant acquirers. The present diagram has however been simplified to show how an actual transaction may be processed.

In the following description, reference is made to a cash register. It will be understood that a cash register may be a stand-alone register, an EPOS device, or part of a more complex system. Where the register is a terminal device communicating with a central processing system, for example a local server, any software referred to in this description may be resident in a central processor, or elsewhere. Where reference is made to “register software”, it is not intended to be restricted to software resident in the register.

In operation the transactor 11 makes a purchase at or with merchant 12. A clerk inputs item prices for good or services in a cash register by way of the register keyboard or a bar code. In response to input of a “total” key the register totals the price. The register displays the total price for the clerk and the transactor. The register responds to the “total” key to perform a number of functions, including for example preparation of commands to update stock control data and preparation of loyalty data, and also causes display of a prompt to make an additional payment to round-up the cost of the transaction to the nearest whole dollar. In exchange for the goods or services provided by the merchant, the transactor provides a credit or debit card to merchant card terminal 12a and makes an information entry into merchant card terminal 12a,

In a first embodiment, the card terminal has a slot for, for example, for enabling a credit or debit card to be read, and a keypad enabling identification data to be input. In some examples, the data may be a personal identification number or pin. To that end the keypad typically has 10 number entry keys, a “confirm” key and a “reject” key. In this first embodiment, the processing machine is connected to the cash register and has its own display. In this embodiment, the display of the processing machine is used to display the prompt to the transactor.

A message may be displayed on the display of the processing machine to query a transactor as to whether it is desired to round-up the transaction. The message may prompt a transactor to key “confirm” if rounding up is desired, and “reject” if not. If no response is made by the end of the predetermined period, the system defaults to “do not round up”. For example, the system defaults to a position which sets the additional amount to zero or which does not include an additional amount in the message.

Upon receiving a “confirm” entry indicative of a decision to round up, the round up amount is calculated, and a new message is displayed on the display of the processing machine, prompting a transactor to key “confirm” or “reject”. The “confirm” and “reject” keys are monitored for a predetermined period, and if an “confirm” input is received, a message is displayed prompting a transactor to enter a pin. The checks made on the pin may be conventional.

In an alternative embodiment, the clerk asks the transactor whether or not they would like to round-up the transaction for the purposes of the third party recipient. The transactor informs the clerk of the chosen option and the decision is logged into the cash register by the clerk. If the decision is not to round-up then the transactor pays for the total amount displayed on the cash register and the transaction is completed. If the transactor decides to round-up the clerk enters the decision into the register that computes the rounding-up calculation and displays a new whole dollar amount.

The above embodiments assume that the only option is to round up the transaction amount. In other embodiments, this may be one option, with another for example allowing a set fixed amount to be added, or a set percentage. In yet other embodiments, the transactor may be prompted to enter an amount of his/her choice to supplement the cost of the goods/service purchased.

In each of these embodiments, the transaction is approved after interaction between card and identity information input by the transactor.

In some cases the card terminal may attempt to “negotiate” with the transactors card whether this would be considered a low risk transaction by the card issuer. If the card agrees that this can be treated as low risk the transaction is completed locally, and becomes final.

If the card rates the transaction as higher risk, or if the merchant has so programmed the card terminal, a message may be sent for specific authorization by the card issuer relevant to the card concerned. This message is sent via the communication path to the merchant acquirer 23, and also transmitted onto the card provider 31.

The card provider 31 determines whether the transaction is to be authorized—a check may be performed to see that the transactor's account contains sufficient funds or credit for the value of the transaction whose authorization is sought.

Assuming the result is positive, a message is sent via the merchant acquirer to the merchant's card terminal 12.

The merchant's card terminal reads the message and opens it. A receipt from the cash register may contain not only the details of the purchase of goods or services but also information on the additional amount paid by the transactor.

A message sent may include information obtained from the transactor and information derived from computation and data input that includes generic data and specific data. The message may be in a standard format, with specified message fields for specific data items.

Examples of generic data of the electronics funds transfer system software are i) a merchant identifier, and ii) the recipient identifier for the additional amount.

Examples of specific data obtained from the card terminal are; i) transactor account identifier, ii) card scheme identifier and iii) the card issuing bank identifier. Examples of specific data obtained from the register computations are; i) merchandise total, ii) rounding-up amount and iii) total transaction amount.

The merchant acquirer 23 reads the received message and, for example, by examining the contents of predetermined message field derives from it the merchant identifier and an accompanying identifier for the goods total, rounding-up amount and the total amount.

In one alternative simple embodiment, the rounding-up amount itself is not sent, but instead a flag bit or flag field is set in the message, along with the merchandise total. In this case the merchant account provider's computer system is programmed to respond to the flag by adding the difference between the merchandise total and the nearest whole currency amount upwards to a “third party credit” database, and to note the merchandise total

In the strictest of senses the processes above may not actually be considered as triggering the money to go off anywhere. This process might be considered as “reserving” a transaction, which is usually followed up often at the end of the day by a batch message, one of the purposes of which is to marry up all those locally agreed transaction with those for which authorization has been sought.

The merchant acquirer 23 accepts the total value amount corresponding to the merchandise identifier. This corresponds to the amount of funds to be transferred from a merchant acquirer account to a merchants account to cover the cost of the merchandise and the rounding-up amount.

The merchant acquirer 23 accepts third part recipient identifier(s) for the rounding-up amount(s).

The merchant acquirer 23 calculates a service fee (%) payable to the Merchant for providing the rounding-up service, as agreed with the third party recipient, and accrues these fees

The merchant acquirer 23 subtracts the accrued amount from the monthly interchange fees payable by each merchant to the MAP for providing the merchant account service.

The merchant acquirer 23 calculates a service fee (%) payable to itself for providing the additional amount service as agreed as part of the membership agreement with the third party recipient

The merchant acquirer 23 transfers this amount into the merchant acquirer's own account

The merchant acquirer 23 calculates an additional service fee (%) payable to each Card Scheme for participating in the rounding-up scheme, as part of their membership agreement with the Card Scheme.

The merchant acquirer 23 transfers these amounts into Card Schemes' accounts using an appropriate identifier

Monthly statements are sent to each Card Scheme that account for the rounding up transactions.

The merchant acquirer 23 calculates an additional service (interchange) fee (%) payable to each Card Issuer for participating in the rounding-up scheme, as part of their membership agreement with the card scheme.

The merchant acquirer 23 transfers these amounts into the Card Issuers' accounts using an appropriate identifier.

Monthly statements are sent to each Card Issuer that account for the rounding-up transactions.

For each rounding-up transaction the MAP calculates the residue of the additional amount, less the fees specified allocated to the Merchant, the Card Scheme and the Card issuer.

The merchant acquirer 23 transfers this residue into the third party recipients' account using appropriate identifiers.

The merchant acquirer 23 communicates to the Card Issuer the additional information on rounding up and allocations to the third party recipient.

The Card Issuer may present the additional information in routine statements to the Transactor.

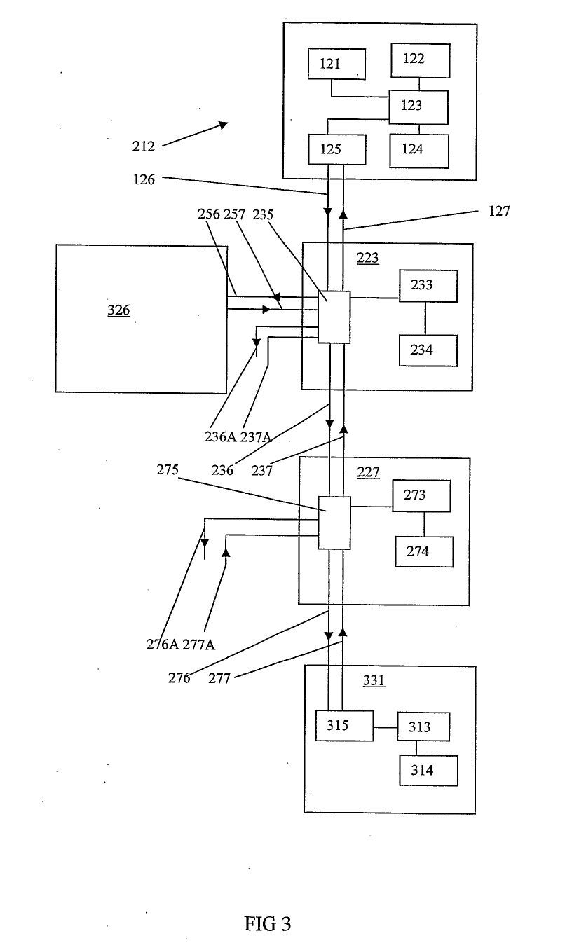

Referring to FIG. 3, a more detailed overview of operation of a preferred embodiment will now be given:

An embodiment of a card terminal 212 has a keypad 121, a display 122, a processor 123, storage circuitry 124 and an input/output device 125. The keypad 121 is connected to supply data to the processor 123, which in turn is connected to apply data to the storage circuitry 124, and to cause the display 122 to display appropriate messages. The processor 123 is also connected to the input/output circuitry 125.

The input/output circuitry 125 is connected to communicate via outward communication path 126, and to receive inward communications via inward communication path 127. The other ends of the communication paths are connected to input/output circuitry 235 of the merchant acquirer computer system 223. It will be understood that two separate physical layer paths may not be required.

An embodiment of the merchant acquirer computer system 223 contains a processor 233, and storage circuitry 234. The processor 233 is connected to supply data to and receive data from the input/output circuitry 235, and also to supply data to, and receive data from the storage circuitry 234.

The input/output circuitry 235 is further connected to communicate via outward communication path 236, and to receive inward communications via inward communication path 237. The other ends of the communication paths are connected to input/output circuitry 275 of the card scheme computer system 27. As will be noted from the drawing, the input/output circuitry 235 is further connected to communicate via second outward communication path 236a, and to receive inward communications via second inward communication path 237a. These second paths indicate figuratively the fact that there may be more than one card scheme computer system 27. Selection of the appropriate card scheme computer system may be effected by the merchant acquirer, for example based on the number of the card being used.

An embodiment of the card scheme computer system 227 contains a processor 273, and storage circuitry 274. The processor 273 is connected to supply data to and receive data from the input/output circuitry 275, and also to supply data to, and receive data from the storage circuitry 274.

The input/output circuitry 275 is further connected to communicate via outward communication path 276, and to receive inward communications via inward communication path 277. The other ends of the communication paths are connected to input/output circuitry 315 of the card issuer computer system 331. As will be noted from the drawing, the input/output circuitry 275 is further connected to communicate via second outward communication path 276a, and to receive inward communications via second inward communication path 277a. These second paths indicate figuratively the fact that there may be more than one card issuer computer system 331. Selection of the appropriate card issuer computer system may be effected by the card scheme computer system 227, for example based on the number of the card being used.

There is yet a further connection for the input/output circuitry of the merchant acquirer computer system, namely to enable it to communicate via outward communication path 256, and to receive inward communications via inward communication path 257 to the computer system 326 of an automated clearing house. It will be understood that two separate physical layer paths may not be required.

In operation, a merchant may enter the value of the transaction to the card terminal 212 using the keypad 121. In response to completion of entry of value, a program running on the processor 123 may then cause a message to be displayed on the display 122 to query a transactor as to whether it is desired to round-up the transaction value. The message may prompt a transactor to key “confirm” if rounding up is desired, and “reject” if not. The program running on the processor 123 causes the processor to monitor the “confirm” and “reject” keys for a predetermined period, and if an input on either is received, it causes storage of the transactor response in a storage circuitry 124. If no response is made by the end of the predetermined period, the program defaults to “do not round up”.

Upon receiving a “confirm” entry indicative of a decision to round up, the program may cause the processor 123 to calculate the round up amount, and may cause the processor to supply a new message to the display 122, prompting a transactor to key “confirm” or “reject”. The program monitors the “confirm” and “reject” keys for a predetermined period, and if an “confirm” input is received, the processor 123 causes a message to be displayed on display 122 prompting a transactor to enter a pin. The checks made on the pin may be conventional. Alternatively, the program may calculate the round up amount before any confirm entry is received.

This embodiment assumes that the only actions are to round up the transaction amount, or not. In other embodiments, this may be one option, with another for example allowing a set fixed amount to be added, or a set percentage. In yet other embodiments, the transactor may be prompted to enter an amount of his/her choice to supplement the cost of the goods/service purchased.

In each of these embodiments, the transaction is approved after interaction between card and identity information input by the transactor.

In some cases the processor of the card terminal 212 may be programmed to attempt to “negotiate” with, for example data stored in a so-called “chip” of the transactors card whether this would be considered a low risk transaction by the card issuer. If the card agrees that this can be treated as low risk the transaction is completed locally, and becomes final. Data on the transaction, including the amount of the transaction itself and the amount, if any, of “rounding up” are then stored in the storage circuitry 124.

If the card rates the transaction as higher risk, or if the merchant has so programmed the card terminal 212, the processor 123 causes a message to be sent via input/output circuitry 125, and communication path 126 to request specific authorization by the card issuer 331 relevant to the card concerned. To create the message, the processor 123 sums the transaction amount with any round-up amount to provide an amount total, and stores details in the storage circuitry 124. The message includes the amount total, information to identify of the credit card, and information to identify the merchant card terminal 212. This message is sent in an encrypted form via the communication path to the merchant acquirer 223, where it is logged into a request database of the storage circuitry 234 of merchant acquirer computer system 223. The processor 233 of the merchant acquirer computer system 223, and also transmitted onto the card issuer 331. In other embodiments for example where secure data transmission can be provided without encryption, encryption may not be used.

Routing of the message to the correct card issuer may be performed by the merchant acquirer 223, or by a card scheme computer system. The routing may be performed by examining card data—for example the leading digits of a card number may provide the routing information.

Algorithms are run by the computer system by the card issuer computer system 331 to determine whether the transaction is to be authorized—these may include a check to see that the transactor's account contains sufficient funds or credit for the value of the transaction whose authorization is sought.

Assuming the result is positive, the card issuer's computer 331 provides a message (typically containing encrypted information) via the merchant acquirer to the card terminal 212.

The card terminal 212 reads the authorization message. In this embodiment, the card terminal 212 does not send back any information indicating that authorization has been received, and the system relies on the processor 123 of the card terminal 212 “remembering” that a request has been sent and “reminding” the card issuer 331, if a reply is not received.

In response to reading the authorization message, in other embodiments the fact that authorization has been received is then enabled to be notified to the merchant acquirer 223 by sending another message over the first communication path. The notification may be a direct and automatic response to the opening of the authorization message, or some user interaction may be needed.

After, or in response to, authorization the processor 123 of the card terminal 212 sends a data message (which may be encrypted) representative of the transaction that has been authorized, or for which no express authorization is needed via paths 126,236 to the merchant card acquirer 223, card scheme and card issuer 331. This data message may include information obtained from the transactor, such as a pin, information derived from computation by the processor 123 and data input that includes generic data and specific data. The message may be in a standardized format, with specified message fields for specific data items. The message or some components of the message may be stored in the storage circuitry 124. For example in one embodiment, the storage circuitry 124 stores the specific data identified below, along with a transaction identifier. The transaction identifier may be a transaction number; it may additionally include time and date of transaction.

Examples of generic data of the electronics funds transfer system software are i) a merchant identifier, and ii) the recipient identifier for the additional amount.

Examples of specific data obtained from the card terminal are: i) transactor account identifier, ii) card scheme Identifier and iii) the card issuing bank identifier. Examples of specific data obtained from the register computations are; i) merchandise total, ii) rounding-up amount and iii) total transaction amount.

The processor 233 runs programs to process the message data. Specifically, in this embodiment the programs cause:
i) The merchant acquirer processor 233 to parse the received message by examining the contents of predetermined message fields to derive from it a merchant identifier and data indicative of the goods; total, and data indicative of the rounding-up amount. Where more than one third party recipient participates, the processor 233 also extracts from the relevant message field a third party recipient identifier. This data is stored along with other messages fields in storage circuitry 234.
ii) The merchant acquirer processor 233 to calculate and store in storage circuitry 234, a service fee (%) payable to the merchant for providing the rounding-up service, as agreed with the third party recipient, and accrues these fees.
iii) The merchant acquirer processor 233 to subtract the accrued amount from a monthly interchange fees payable by each merchant to the merchant acquirer for providing the merchant account service; this is stored in storage circuitry 234.
iv) The merchant acquirer processor 233 to calculate and store in storage circuitry 234 a service fee (%) payable to itself for providing the additional amount service as agreed as part of the membership agreement with the third party recipient.

In the present embodiment, the program of the processor 233 periodically causes the processor to extract data from the storage circuitry 234 to form one or more batches of information that are to be sent to the automated clearing house 326, instructing it to make payments to the bank accounts of relevant recipients. The data consists of data indicative of a recipient (e.g. merchant—derived from merchant identifier data held in the database; third party recipient—derived from third party recipient data held in the database; itself—fixed data) and each recipient data item accompanied by an amount accrued by summing the database contents for that identifier.

The merchant acquirer also provides periodic reports to each recipient by extracting relevant information from its database and sending electronically or otherwise to the recipient. A log-in system may allow recipients to see more current information on amounts that have been paid or are to be paid.

The system is able to allow the third party recipients to determine the origins of round-up amounts, either by original transactor's card number, by merchant or by merchant type. However legislation, such as data protection legislation, or commercial confidentiality issues may prevent this feature from being used.

In some embodiments, instead of a credit card the means of purchase may comprise a debit card, charge card or any other means by which a transactor account identifier is presented in settlement.

In some embodiments, instead of a credit card the means of purchase uses cash or a prepayment card.

In some embodiments, instead of the transaction being mediated by a Clerk, the transactor interacts directly with a register display, for example when entering a security code to validate card payment, at an in store self check-out, or over the internet.

In some embodiments, instead of rounding up to a nearest whole currency unit amount, or to another convenient figure, a predetermined additional amount (for example one dollar) is added, or there may be a combination of rounding and adding a preset amount, or the additional amount is specified by the transactor,

Utilizing existing personal identifiers (credit/debit/charge cards, or for instance a loyalty card) a real-time decision can be made to credit any (third party participant) account with an amount additional to the transaction value. The identifiers and accounts that enable this are integral to the system software and established by agreement between any or all of players (the merchant, merchants card acquirer, the card scheme and the card issuer) and a third party to whom the funds are credited. The additional processes necessary to implement third party credits integrate with the existing electronics funds transfer processes and infrastructure. No additional apparatus is needed although changes to the software are necessary. No player in the system need be neutral and the invention allows for crediting by the recipient third party, any or all of the players for participation. The third party destination account can be determined by any of the participants. The third party function may be performed by a new entity or any of the existing players.

The system may be implemented in an e-commerce environment, using for example, a transactor's own computer, rather than a card terminal. Although the invention has been described mainly in the context of cards, it will be appreciated that other data carriers could be used.

Features of certain embodiments:

The options for the Transactor to contribute an amount to a third party recipient are generated by the point of sale software at the point at which the cost of merchandise is totalled or where settlement is offered. Transactors choose their preferred option.

The only information needed from the Transactor to enable their contribution to the third part recipient is their decision to contribute.

The necessary recipient identifiers are provided by the system (not the Transactor or a Transactors Card) as part of the point of sale software and are communicated to the other players in the payment process network.

Selection of the option to contribute triggers an independent separable transaction for the third party recipient. Attributes of the transaction i.e. their destination and interchange fees, can be determined anywhere within the payment process network except the individual transactor's account. The decision as to where in the network process the crediting of the third party recipient takes place is determined by the third party recipient and the players.

The Merchant no longer need be neutral, and can receive fees.

A mechanism may be provided in which the merchant and other players may be rewarded for their participation through the interchange fee structure associated with the additional amount, allocated by any or all of the players through agreement with the third party recipient.

Embodiments of the invention have now been described. The invention is not restricted to the described features.

1. A card terminal having means for entering transaction value information indicative of a first amount, means for entering data indicative of an additional amount, means for storing the transaction value information and the data indicative of the additional amount, and means for creating a message for electronic transmission, the message including data indicative of the first amount in association with data indicative of a first recipient, and data indicative of the additional amount in association with data indicative of a second recipient.

2. The card terminal of claim 1, further having means for creating a request for authorisation, said request indicative of the sum of the first and additional amounts.

3. The card terminal of claim 1, having means for reception of an authorisation message, and means for enabling the means for creating a message to output the message in response to said reception.

4. The card terminal of claim 1, having means for interacting with a card to determine whether authorisation is not deemed necessary and means for enabling the means for creating a message to output the message in response to said determination.

5. The card terminal of claim 1 wherein the additional amount is predetermined, and the means for entering an additional amount comprises a “confirm” key.

6. The card terminal of claim 1, wherein the means for entering an additional amount allows a user to choose between predetermined amounts.

7. The card terminal of claim 1, wherein the means for entering an additional amount allows a user to enter an arbitrarily selected amount.

8. The card terminal of claim 1, operable to calculate a difference between the first amount and the next highest whole currency unit amount, and wherein the means for entering an additional amount allows a user to elect said difference as said additional amount.

9. The card terminal of claim 1 wherein the means for entering an additional amount comprises a “confirm” key, and wherein the card terminal further comprises means for defaulting, in the event that no response is made after a predetermined period, to setting the additional amount to zero or not including an additional amount in the message.

10. A computer system such as a merchant acquirer computer system having a transaction database, and a plurality of communication ports, having means for receiving a single message at a respective communication port, the message having predetermined fields containing data indicative of a first amount, data indicative of a first recipient, data indicative of an additional amount and data indicative of a second recipient and for storing the data indicative of a first amount in association with the data indicative of a first recipient, and the data indicative of an additional amount in association with the data indicative of a second recipient.

11. A computerised payment system comprising a data entry device, a computer system remote from the data entry device, with a first communication path linking the data entry device to the computer system, and a second communication path linking the computer system to the data entry device, wherein the data entry device has means for inputting a first transaction data indicative of a first value, means for entering second transaction data indicative of a second value, and means for outputting information indicative of the first and second transactions to the first communication path for transfer to the computer system, and the computer system is operable to direct funds related to the first value to a first recipient and funds related to the second value to a second recipient.

12. A method of electronic payment by a first party to a second party comprising:
using a payment terminal, providing the first party with the opportunity to elect to pay to a third party a first amount additional to a second amount to be paid to the second party;
if the first party elects to pay the additional amount, transferring information from the payment terminal to a remote computer system such as a remote merchant acquirer computer system, the information containing data indicative of the first amount, the second amount, the identity of the first party and the second party and the third party; and
accessing the information, and using it to cause appropriate transfer of funds to the second and third parties.

13. The method of claim 12, further comprising storing the information at the computer system.

14. A method of electronic payment by a first party to a second party using a data carrier, comprising:
using a payment terminal, providing the first party with the opportunity to elect to pay to a third party a first amount additional to a second amount to be paid to the second party;
if the first party elects to pay the additional amount, transferring information from the payment terminal to a remote merchant acquirer computer system, the information containing data indicative of the first amount, the second amount, the identity of the first party and the second party and the third party, the information further comprising data indicative of an issuer of the data carrier;
storing the information at the merchant acquirer computer system;
transferring selected items of stored data to the issuer of the data carrier whereby payment is made from the card issuer to the merchant account provider;
processing the information and using it to cause appropriate transfer of funds to the second and third parties.

15. The method of claim 14, wherein the step of transferring selected items of stored data comprises collecting together stored data relevant to respective card issuers, and sending respective batches of data to the relevant card issuers.

16. The method of claim 14, further comprising an authorization step, in which the payment terminal transmits data indicative of the sum of the first and second amounts along with data indicative of the first party.

17. The method of claim 16, wherein data transmitted at least during the authorization step is transmitted in encrypted form.

18. The method of claim 17, wherein the authorization step further comprises transferring authorization data to the payment terminal.

19. The method of claim 18, wherein the step of transferring information from the payment terminal to a remote merchant acquirer computer system is enabled in response to receipt of authorization data at the payment terminal.
